(19) United States
(12) Patent Application Publication
(10) Pub. No.: US 2013/0189460 A1
(43) Pub. Date: Jul. 25, 2013

(54) Articles with Applied Recycled Souvenir Particulate and Method of Manufacture

(71) Applicant: Laurence J. Hamilton, Penfield, NY (US)

(72) Inventor: Laurence J. Hamilton, Penfield, NY (US)

(21) Appl. No.: 13/746,774

(22) Filed: Jan. 22, 2013

Related U.S. Application Data
(60) Provisional application No. 61/589,025, filed on Jan. 20, 2012.

(51) Int. Cl. B32B 1/02; B41M 3/00; B32B 3/10

(52) U.S. Cl. CPC B32B 1/02; B32B 3/10; B41M 3/00
USPC 428/34.6; 428/196; 428/35.2; 156/230; 156/277; 101/129

(57) ABSTRACT

Articles created using particulate from recycled souvenirs and a method of decorating articles such as garments with patterns made from ground particulate obtained from noteworthy spectator sport objects such as race car tires, for example, wherein the pattern resembles the nature or characteristic of the recycled item.

### BACKGROUND OF THE INVENTION

The present invention relates to articles created and/or decorated using particulate from recycled souvenirs and a method of manufacture thereof. More particularly, the invention relates to a method of making and/or decorating articles such as garments with ground particulate obtained from noteworthy spectator sport objects such as race car tires, for example.

Many people attending, watching or who are otherwise fans of spectator sports commonly purchase merchandise having a design and/or indicia connected to the event and/or team and/or individual sport participant. Such items may include t-shirts, sweatshirts, shorts, pants, hats, jackets, mugs, glasses, coozies, etc., where the design and/or indicia are printed thereon. Many of these people also desire to obtain an actual article used in the event by the team or individual participant, e.g., a puck used in a game, although the opportunity to acquire these articles by chance (e.g., catching a puck in the stands) is of course very rare. Such items may sometimes be bought as a collectible but are typically expensive due to their direct connection to the event and/or sports participant. In some spectator sports such as auto racing, there are very few opportunities to acquire such articles actually used in a race.

It would therefore be desirable to provide merchandise articles for fans of a spectator sport which is made using an item used by the team or individual sports participant. It would furthermore be desirable to repurpose and recycle used sports items in the manufacturing of such merchandise and thereby have a positive impact on the environment.

### SUMMARY OF THE INVENTION

The present invention addresses the above needs by providing an article with an applied recycled souvenir and a method of manufacturing the article with applied recycled souvenir. An item used in a spectator sport is considered to have souvenir value and is recycled by converting (e.g., by grinding) it into a particulate. The particulate (comprised of many individual granular particles) may be formed of a predetermined size and shape; e.g., with a particle size of between about 0.1 and 1500 microns, more preferably with a particle size of between about 0.5 and 800 microns and most preferably with a particle size of between about 1 and 400 microns. If desired, the original nature of the souvenir may be further emphasized or exaggerated by using even larger particle sizes to augment the visual and tactile characteristic of the design on the article. The particulate may also be a combination of granular sizes to obtain the desired visual and tactile effect. When the souvenir is a tire, for example, the particulate may be formed into a mixture of various sized particles such that when applied to the article, the particulate layer forms a raised surface that has peaks and valleys which are visually and tactically very evident. The larger particles (e.g., up to 1 mm or more in size) create actual “chunks” of the tire which provides an immediate indication of the nature of the actual souvenir.

The particles may be formed into random particle shapes or specific particle shapes (e.g., spherical, oblong, squared, etc. or any combination thereof). The particles may be deposited on the article in a specific or nonspecific (i.e., random) laydown pattern according to particle shape and/or size. The term “laydown pattern” as used herein means the pattern the individual particles make within the outline of the overall recycled souvenir design pattern. An article such as a garment (e.g., t-shirt) is decorated with the recycled souvenir particles, wherein in a first embodiment, the method comprises the steps of:
a) converting (e.g., by grinding) at least a portion of said souvenir into a particulate;
b) screen printing a colored ink layer onto the article in a desired recycled souvenir design pattern (which may be a representation of the nature of the recycled souvenir (e.g., if the souvenir is a hockey puck, the pattern may be designed to look like a hockey puck));
c) screen printing a first coat liquid adhesive layer onto the colored ink layer in said desired souvenir pattern;
d) distributing the particulate in a laydown pattern onto said liquid adhesive layer;
e) removing excess particulate from the article not located on the liquid adhesive layer (e.g., by vacuum pick-up);
f) drying (e.g., flash drying) the first coat liquid adhesive layer and thereby bonding the particulate to the first coat liquid adhesive layer to form a first bonded layer at a preferred drying temperature of approximately 300 degrees Fahrenheit for a preferred duration of between about 15 and 20 seconds;
g) screen printing a second coat liquid adhesive layer onto the first bonded layer and thereby forming a multilayer composite;
h) if necessary, curing the multilayer composite (e.g., via conveyor oven at a preferred curing temperature of approximately 350 Fahrenheit for a preferred duration of between about 30 and 35 seconds); and
i) if necessary, heat pressing the multilayer composite at a preferred temperature of approximately 375 degrees Fahrenheit for a preferred duration of between about 15 and 18 seconds.

The drying and curing steps may vary depending in the types of inks used, some of which may be quick drying at room temperature thereby negating the need for a separate drying/cure step. The colored ink layer may be any suitable screen printing ink (e.g., plastisol) and the adhesive layer may be any suitable material which will bind with the souvenir particulate. The adhesive layer may be a screen printing glue or may be a screen printing clear ink (e.g., clear plastisol which has been found to be an adequate particulate binder). It is noted that final step i) is process dependent, i.e., this step may only be necessary when decorating certain types of article such as t-shirts, for example. It is furthermore understood that the steps may be combined and/or performed in a different order. For example, in a second alternate embodiment the colored ink and first adhesive layer are combined together prior to depositing the mixture on the article, the alternate method comprises the steps of:
a) converting (e.g., by grinding) at least a portion of said souvenir into a particulate;
b) mixing colored ink and a liquid adhesive together to form a homogeneous base mixture;
c) screen printing the homogenous base mixture onto the article in a desired pattern (which may be a representation of the nature of the recycled souvenir (e.g., if the souvenir is a hockey puck, the pattern may be designed to look like a hockey puck));
d) distributing the particulate onto said homogenous base mixture;
e) removing excess particulate from the article not located on the ink and liquid adhesive layer (e.g., by vacuum pick-up);
f) drying (e.g., flash drying) the homogenous base mixture with the particulate thereon to form a first bonded layer at a preferred drying temperature of approximately 300 degrees Fahrenheit for a preferred duration of between about 15 and 20 seconds;
g) screen printing a second coat liquid adhesive layer onto the first bonded layer and thereby forming a multilayer composite;
h) if necessary, curing the multilayer composite (e.g., via conveyor oven at a preferred curing temperature of approximately 350 Fahrenheit for a preferred duration of between about 30 and 35 seconds; and
i) if necessary, heat pressing the multilayer composite together at a preferred temperature of approximately 375 degrees Fahrenheit for a preferred duration of between about 15 and 18 seconds.

As with the first embodiment, it is noted that final step i) is process dependent, i.e., this step may only be necessary when decorating certain types of articles such as t-shirts, for example. It is furthermore understood that the steps may be combined and/or performed in a different order. As stated above, the drying and curing steps may vary depending in the types of inks used, some of which may be quick drying at room temperature thereby negating the need for a separate drying/cure step and/or heat/press source.

In yet another embodiment, a method of decorating an article with a recycled souvenir comprises the steps of:
a) converting at least a portion of said souvenir into a particulate;
b) providing an adhesive backing layer on a non-binding release paper;
c) screen printing a colored ink layer onto the adhesive backing layer in a desired pattern;
d) screen printing a first coat liquid adhesive layer over the colored ink layer;
e) distributing the particulate onto said first coat liquid adhesive layer;
f) removing excess particulate from the article not located or bonded on the liquid adhesive layer;
g) drying (e.g., flash drying) the first coat liquid adhesive layer with the particulate thereon to form a first bonded layer at a preferred temperature of approximately 300 degrees Fahrenheit for a preferred duration of between about 15 and 20 seconds;
h) screen printing a second coat liquid adhesive layer onto the first bonded layer and thereby forming a multilayer composite;
i) if necessary, curing the multilayer composite at a preferred curing temperature of approximately 350 Fahrenheit for a preferred duration of between about 30 and 35 seconds; and
j) if necessary, heat pressing the multilayer composite at a temperature of approximately 375 degrees Fahrenheit for between about 15 and 18 seconds to thereby form the design pattern as a decal; and
k) removing the decal from the release paper and applying the decal to an article.

In yet a further embodiment, a method of decorating an article with a recycled souvenir comprises the steps of:
a) converting at least a portion of said souvenir into a particulate;
b) screen printing a colored ink layer onto a patch of material in a desired pattern;
c) screen printing a first coat liquid adhesive layer over the colored ink layer;
d) distributing the particulate onto said liquid adhesive layer;
e) removing excess particulate from the article not located or bonded on the liquid adhesive layer;
f) drying (e.g., flash drying) the first coat liquid adhesive layer with the particulate thereon to form a first bonded layer at a preferred temperature of approximately 300 degrees Fahrenheit for a preferred duration of between about 15 and 20 seconds;
g) screen printing a second coat liquid adhesive layer onto the first bonded layer and thereby forming a multilayer composite on said patch;
h) if necessary, curing the multilayer composite at a preferred curing temperature of approximately 350 Fahrenheit for a preferred duration of between about 30 and 35 seconds; and
i) applying said patch to an article.

The method may further comprise the step of marking the garment with a design and/or indicia indicating the source of the souvenir (e.g., the number and/or name of the sports participant or team who used the souvenir in the sporting event). The souvenir may be any desired item which is recycled and applied to any desired object. For example, a tire that has been used by a race car may be the recycled souvenir which is applied to a garment. Race cars are known to use several sets of tires during a single race. These used tires are then discarded as with regular automobile and truck tires which typically end up in a land fill, with tremendous negative impact to the environment. These tires may instead be recycled into a particulate and applied to merchandise objects in accordance with the teachings of the present invention.

Examples of other souvenir items may include, for example, hockey pucks used in a hockey game, skateboards or skateboard wheels used by a famous skateboarder, a football helmet from a famous football player, a football used in a football game, a baseball, bat or helmet used in a baseball game, soccer shin pads or a soccer ball used in a soccer game, etc. The particulate may be left in the color of the original souvenir or optionally colored (e.g., by spraying or soaking the particulate with an ink).

The above-mentioned invention and method of manufacture are unique in that they provide not only the opportunity for fans to own a souvenir, but also provide for an extremely realistic facsimile of the original collectible souvenir material making the overall product appealing in a way that no prior art has been able to accomplish. In particular, the distribution of the recycled particulate directly into and/or onto the adhesive layer allows many options for creating the desired visual and tactile (e.g., 3D) pattern. The particulate laydown pattern may thus be customized as desired to achieve a very close simulation (or playful exaggeration or deliberate non-simulation, if desired) of the original souvenir type and/or characteristic and/or material(s).

### BRIEF DESCRIPTION OF THE DRAWING

FIG. 1a and 1b are front and rear views, respectively, of a t-shirt according to one embodiment of the invention;

FIGS. 2a and 2b are front and rear views, respectively, of a cap according to another embodiment of the invention;

FIGS. 3a, 3b and 3c are front, rear and side views, respectively, of a sweatshirt according to another embodiment of the invention;

FIGS. 4a and 4b are front and rear views, respectively, of a glass according to another embodiment of the invention;

FIG. 5 is a front view of a bag according to another embodiment of the invention;

FIG. 6 is a block diagram of the individual layers according to an embodiment of the invention;

FIG. 7 is a fragmented view of FIG. 3b showing an application of the invention with examples of particulate laydown patterns; and

FIGS. 8A-8D are simplified side elevational views of particulate laydown patterns and a decal embodiment of the invention.

### DETAILED DESCRIPTION OF PREFERRED EMBODIMENTS

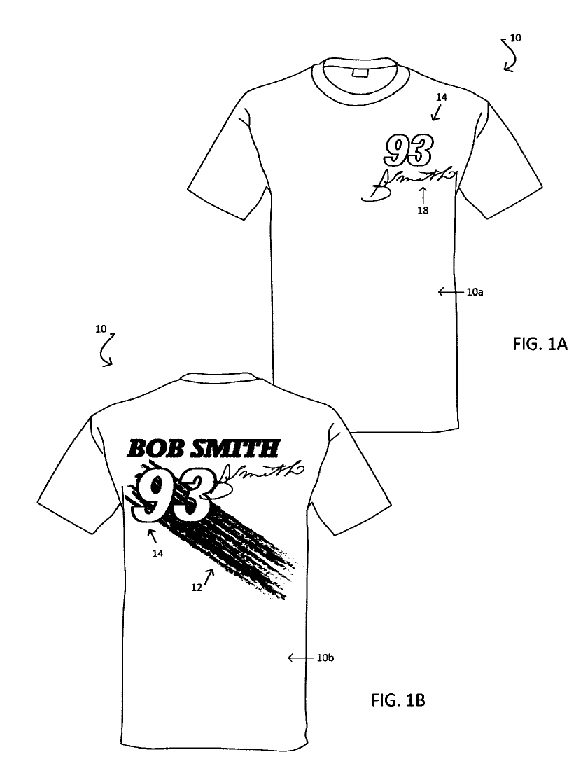

Referring now to the drawing, there is seen in FIGS. 1a and 1b a first embodiment of the invention in the form of a t-shirt designated generally by the reference numeral 10 having a front 10a and rear 10b. Any part of t-shirt 10 may have a pattern and design and/or indicia applied thereto in accordance with the inventive method described above. In this embodiment, the recycled souvenir is a used tire from the car of race car driver Bob Smith driving car number “93” and the article to which the recycled souvenir is applied is a t-shirt. More particularly, the used tire (not shown) is converted (e.g., by grinding) into particulate and applied to any part of t-shirt 10 (in this example, to rear surface 10b) in a souvenir design pattern 12 which resembles a tire track. Indicia indicating the source of the souvenir is placed on the article and may be applied over a portion of or adjacent to pattern 12. In the present example, the indicia is the name of the race car driver “Bob Smith” and the number of his race car “93” as indicated by reference numerals 14 and 16, respectively. The race car driver's signature 18 may also be applied as indicia. A potential purchaser may thus instantly recognize the source of pattern 12 although further identifying detail may be provided if desired (e.g., a tag or label attached to the t-shirt indicating the tire track is from the actual used tire of car 93 driven by Bob Smith).

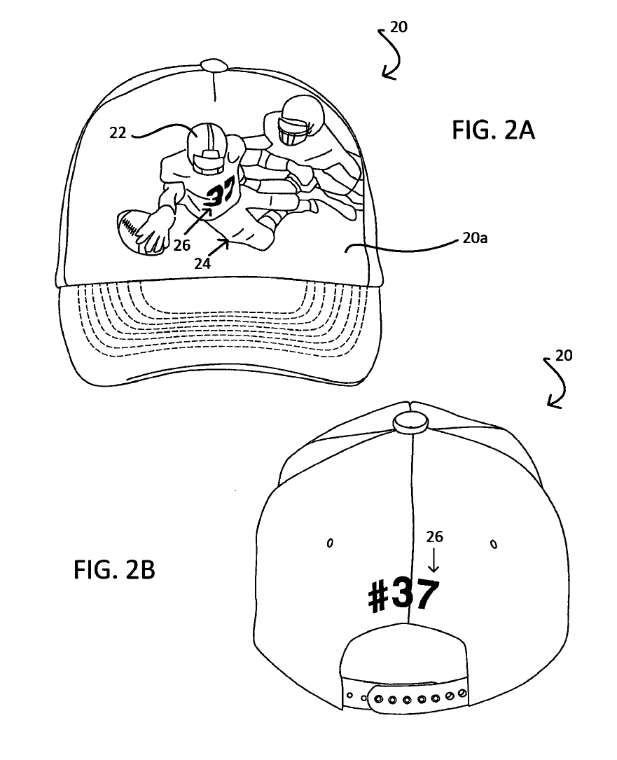

FIGS. 2a and 2b show a second embodiment of the invention in the form of a baseball cap designated generally by the reference numeral 20 having a front 20a and rear 20b. Any part of cap 20 may have a pattern and design and/or indicia applied thereto in accordance with the inventive method described above. In this embodiment, the recycled souvenir is a helmet used in a game by player number “37” and the article to which the recycled souvenir is applied is a baseball cap. More particularly, the used helmet (not shown) is ground into particulate and applied to any part of cap 20 (in this example, to front surface 20a) in a souvenir pattern 22 which resembles a helmet. Indicia indicating the source of the souvenir is applied over a portion of or adjacent to pattern 22. In the present example, the indicia is the player and the player's number “37” as indicated by reference numeral 24 and 26, respectively. A potential purchaser may thus instantly recognize the source of pattern 22 although further identifying detail may be provided if desired (e.g., a tag or label attached to the cap indicating the helmet is from an actual helmet used in a game by Player 37).

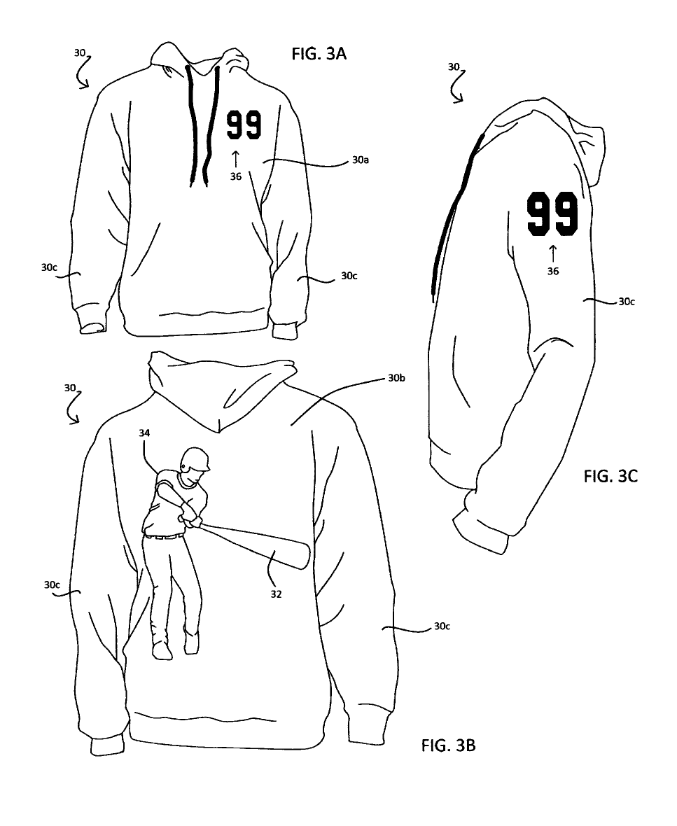

FIGS. 3a, 3b and 3c show a third embodiment of the invention in the form of a sweat shirt designated generally by the reference numeral 30 having a front 30a, a rear 30b and sleeves 30c. Any part of sweatshirt 30 may have a pattern and design and/or indicia applied thereto in accordance with the inventive method described above. In this embodiment, the recycled souvenir is a used baseball bat used in a game by player “99” and the article to which the recycled souvenir is applied is a sweatshirt. More particularly, the used baseball bat (not shown) is ground into particulate and applied to any part of sweatshirt 30 (in this example, to rear surface 30a) in a souvenir pattern 32 which resembles a baseball bat. Indicia indicating the source of the souvenir is applied over a portion of, adjacent to pattern 32 or anywhere else on sweatshirt 30. In the present example, the indicia is an outline of the player and the player's number “99” as indicated by reference numerals 34 and 36, respectively. A potential purchaser may thus instantly recognize the source of pattern 32 although further identifying detail may be provided if desired (e.g., a tag or label attached to the sweatshirt indicating the baseball bat design is from the actual baseball bat used in a game by player number 99).

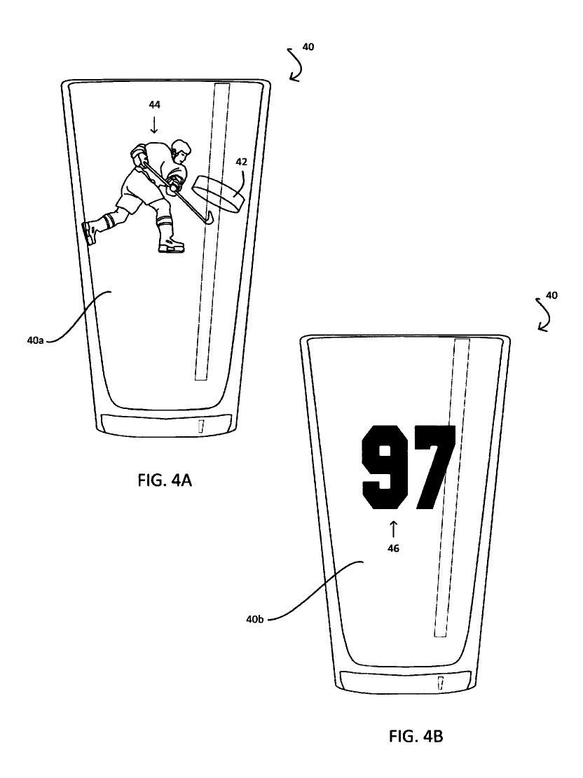

FIGS. 4a and 4b show a third embodiment of the invention in the form of a drinking glass designated generally by the reference numeral 40 having a front 40a and rear 40b. Any part of glass 40 may have a pattern and design and/or indicia applied thereto in accordance with the inventive method described above. In this embodiment, the recycled souvenir is the used hockey puck used in a game by player having the number “97” and the article to which the recycled souvenir is applied is a drinking glass. More particularly, the used hockey puck (not shown) is ground into particulate and applied to any part of glass 40 (in this example, to front surface 40a) in a souvenir pattern 42 which resembles a hockey puck. Indicia indicating the source of the souvenir is applied over a portion of or adjacent to pattern 42. In the present example, the indicia is the player and the player's number “97” as indicated by reference numeral 44 and 46, respectively. A potential purchaser may thus instantly recognize the source of pattern 42 although further identifying detail may be provided if desired (e.g., a tag or label attached to the glass indicating the puck design is from the actual puck used in a game by player number 97).

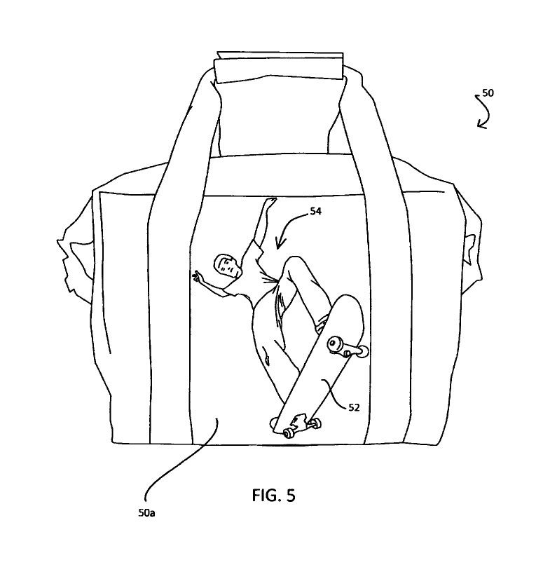

FIG. 5 shows a fourth embodiment of the invention in the form of a tote bag designated generally by the reference numeral 50 having a front panel 50a. Any part of bag 50 may have a pattern and design and/or indicia applied thereto in accordance with the inventive method described above. In this embodiment, the recycled souvenir is a used skateboard and the article to which the recycled souvenir is applied is a tote bag. More particularly, the used skateboard (not shown) and/or wheels is ground into particulate and applied to any part of bag 50 (in this example, to front surface 50a) in a souvenir pattern 52 which resembles a skateboard. Indicia indicating the source of the souvenir is applied over a portion of or adjacent to pattern 52. In the present example, the indicia is the skateboarder as indicated by reference numeral 54. A potential purchaser may thus instantly recognize the source of pattern 42 although further identifying detail may be provided if desired (e.g., a tag or label attached to the bag indicating the skateboard design is from the actual skateboard used by a particular skateboarder.

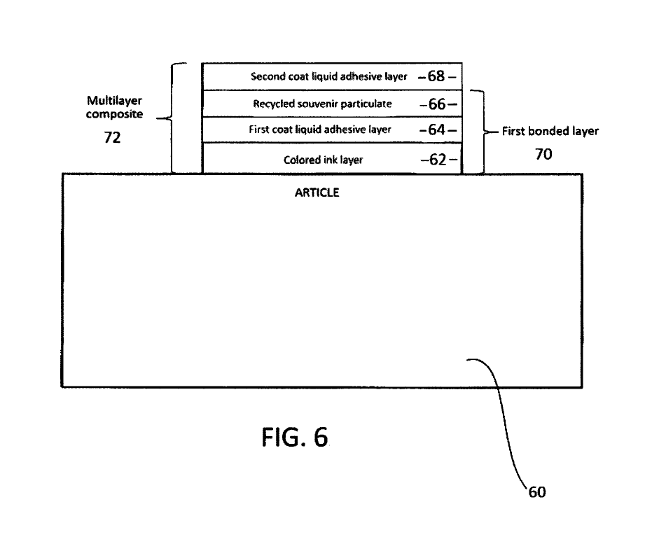

As stated above and referring to FIG. 6, in a first embodiment, the method for applying the recycled souvenir particles to an article 60 comprises the steps of:
a) converting (e.g., by grinding) at least a portion of said souvenir into a particulate;
b) screen printing a colored ink layer 62 onto the article 60 in a desired recycled souvenir design pattern (which may be a representation of the nature of the recycled souvenir (e.g., if the souvenir is a hockey puck, the pattern may be designed to look like a hockey puck));
c) screen printing a first coat liquid adhesive layer 64 onto the colored ink layer 62;
d) distributing the particulate 66 onto said liquid adhesive layer 64;
e) removing excess particulate from the article not located or bonded on the liquid adhesive layer (e.g., by vacuum pick-up);
f) drying (e.g., flash drying) the first coat liquid adhesive layer and thereby bonding with the particulate thereto the first coat liquid adhesive layer on to form a first bonded layer 70 at a preferred drying temperature of approximately 300 degrees Fahrenheit for a preferred duration of between about 15 and 20 seconds;
g) screen printing a second coat liquid adhesive layer 68 onto the first bonded layer and thereby forming a multilayer composite 72;
h) if necessary, curing the multilayer composite 72 (e.g., via conveyor oven at a preferred curing temperature of approximately 350 Fahrenheit for a preferred duration of between about 30 and 35 seconds); and
i) if necessary, heat pressing the multilayer composite 72 at a temperature of approximately 375 degrees Fahrenheit for a preferred duration of between about 15 and 18 seconds.

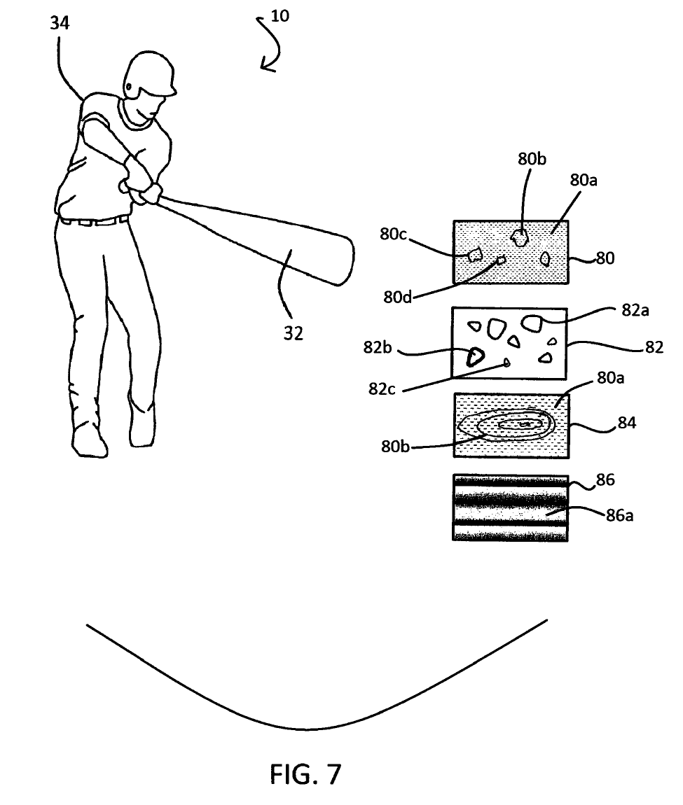

The laydown pattern of the individual particles may be random or customized as desired to achieve the desired visual and tactile effect. For example, as seen in FIG. 7, souvenir pattern 32 is formed in the shape of a baseball bat. A recycled baseball bat is converted into a particulate with the desired particle size and shape such as indicated at boxes 80, 82, 84 and 86. Box 80 illustrates a particulate composition and laydown pattern having a mixture of very small particles 80a combined with randomly shaped and interspersed large, medium and small particles 80b-d, respectively.

Box 82 illustrates a particulate composition and laydown pattern having only randomly shaped and interspersed large, medium and small particles 82a-c, respectively.

Box 84 illustrates a particulate composition and laydown pattern having small linear particles 84a oriented in the same direction with an interior design 84b formed to simulate wood grain (or any other desired design such as a player's number or team, for example) which may be formed with colored ink or particles which are colored darker than background particles 80a.

Box 86 illustrates a particulate composition and laydown pattern 86a which provides a gradient effect. This may be done using particles that have been colored in different shades and laying them down on the article with the different shades separated to provide the desired gradient effect.

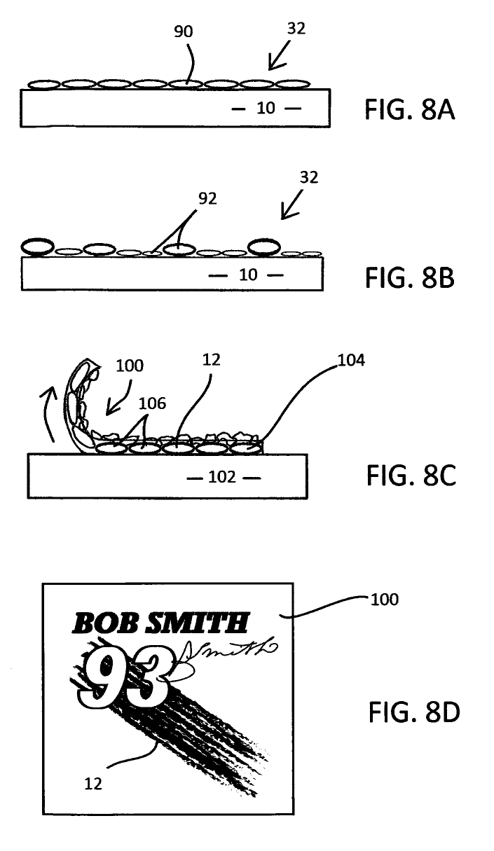

FIG. 8a illustrates a simplified section view of an article such as t-shirt 10 having design 32 formed using a particulate composition having oblong shaped particles 90 which are all of the same size and oriented in the same direction. Various methods may be used to achieve the desired orientation of the particles during the laydown process including using particle orientation frames which physically direct the particles into the desired orientation. Additional materials may also be added to the particulate for this purpose and/or for additional design effect, e.g., adding metal filings which would allow the use of magnets to orient the filing/particle mixture.

FIG. 8B illustrates a simplified section view of an article such as t-shirt 10 having design 32 formed using a particulate composition having oblong shaped particles 92 of different sizes and oriented in the same direction.

As noted above the particle orientation and particle shapes may be of any desired combination.

As an alternative to forming the design pattern directly on the article, FIGS. 8C and 8D illustrate an alternate method where the design pattern is formed as a patch or decal 100 (e.g., applique, transfer, iron-on, press-on, sew-on, static cling, etc.) which may be separately formed either as a unitary piece (decal) or onto any desired piece of material, e.g., fabric, (patch) which is subsequently attached to the desired article. In the embodiment where the back surface of the unitary design or decal includes an adhesive backing for adhesively applying the design/decal to the article, a protective release paper 102 may be applied to the adhesive back surface of the design/decal which may be removed immediately prior to applying the design/decal to the desired article. It can be seen in FIG. 8C that the particle composition and orientation in this example is varied including both oriented particles 104 and non-oriented or randomly placed particles 106. According to the “decal” embodiment, the method comprises the steps of:
a) converting at least a portion of said souvenir into a particulate;
b) providing an adhesive backing layer on a non-binding release paper;
c) screen printing a colored ink layer onto the adhesive backing layer in a desired pattern which may be a representation of the nature of or characteristic of the recycled souvenir (e.g., if the souvenir is a hockey puck, the pattern may be designed to look like a hockey puck);
d) screen printing a first coat liquid adhesive layer over the colored ink layer;
e) distributing the particulate onto said liquid adhesive layer;
f) removing excess particulate from the article not located or bonded on the liquid adhesive layer;
g) drying (e.g., flash drying) the first coat liquid adhesive layer with the particulate thereon to form a first bonded layer at a preferred temperature of approximately 300 degrees Fahrenheit for a preferred duration of between about 15 and 20 seconds;
h) screen printing a second coat liquid adhesive layer onto the first bonded layer and thereby forming a multilayer composite;
i) if necessary, curing the multilayer composite via conveyor oven at a curing temperature of approximately 350 Fahrenheit for a duration of between about 30 and 35 seconds; and
j) if necessary, heat pressing the multilayer composite at a temperature of approximately 375 degrees Fahrenheit for between about 15 and 18 seconds to thereby form the design pattern as a decal; and
k) removing the decal from the release paper and applying the decal to an article.

The steps may be combined and/or performed in a different order (e.g., the colored ink and first coat adhesive layer may be combined prior to screen printing. In this embodiment the particulate composition may have a particulate size of preferably between about 0.1 and 1500 microns, more preferably between about 0.5 and 800 microns and most preferably between about 1 and 400 microns.

According to the “patch” embodiment, the method comprises the steps of:
a) converting at least a portion of said souvenir into a particulate;
b) screen printing a colored ink layer onto a patch of material in a desired pattern;
c) screen printing a first coat liquid adhesive layer over the colored ink layer;
d) distributing the particulate onto said liquid adhesive layer;
e) removing excess particulate from the article not located or bonded on the liquid adhesive layer;
f) drying (e.g., flash drying) the first coat liquid adhesive layer with the particulate thereon to form a first bonded layer, the drying step optionally being with applied heat at a preferred temperature of approximately 300 degrees Fahrenheit for a preferred duration of between about 15 and 20 seconds;
g) screen printing a second coat liquid adhesive layer onto the first bonded layer and thereby forming a multilayer composite on said patch;
h) if necessary, curing the multilayer composite at a preferred curing temperature of approximately 350 Fahrenheit for a preferred duration of between about 30 and 35 seconds; and
i) applying said patch to an article.

The following is a non-limiting list of examples of the types of articles on which the inventive method may be used:

Adhesive Notes, Antenna Pennants, Ash Trays, Automotive Gift Sets, Automotive Emergency Kits, Awards, Plaques and Trophies, Backpacks, Badges and Holders, Bag Clips, Bags, Balls, Bandages and Dispensers, Bandanas, Bar Gifts and Accessories, Bats, Battery-Operated Cars, Beach Items, Beach Towels, Beads, Belts, Belt and Fanny Packs, Big & Tall Apparel, Billiard Accessories, Billiard Cues, Billiard Gift Sets, Binders, Binoculars, Blankets, Bobble heads, Books, Bookmarks, Bottle and Can Openers, Bowling Balls, Bowling Pins and Equipment, Bowls, Briefs, Bracelets, Briefcases, Bumper Stickers, Business Cards and Cases, Buttons, Calculators, Calendars, Cameras, Can and Bottle Coolers, Can and Bottle Drink Sleeves, Candles, Candy Jars, Caps, Car Accessories (Flags, Magnets and Shades), Card Games, Carabiners, Cards (playing/greeting/trading), Carriers, Cases, Cell Phone Accessories, Chairs (Deck, Director, Folding, etc.), Chalk Boards, Checkbook Covers, Christmas and other Ornaments, Cigar Gift Sets and Accessories, Cinch Bags, Clips, Clipboards, Clocks, Coasters, Coats, Coffee Mugs (ceramic and metallic), Coins, Collectibles & Memorabilia, Collectible Stamps, Computer Bags, Accessories and Gift Sets, Containers, Cookie Jars, Coolers (soft and hard sided), Cooler Tailgate Tubs, Corkscrews, Covers, Coozies (aka Cozies and/or Koozies), Crystal, Cuff Links, Custom Gear including Customizable Apparel (your name in collectible material), DVDs & Books, Day Packs, Decals, Decorations, Desk Sets, Desk Top Awards, Accessories and Organizers, Diaries, Desk pads, Diecast Cars, Trucks, other equipment and vehicles and Cases, Displays, Dog Tags, Door Mats, Drinkware, Driving Experience Products and Accessories, Duffel Bags, Ear Buds, Ear Phones, Ear Rings, Electronics, Erasers, Executive Gift Sets, Fans, Fitness and Personal Safety Products, Flags & Banners, Flashlights, Flatware, Flip Flops, Flying Discs, Folders, Folios, Footwear, Frames, Friction and/or Pullback Vehicles, Gambling Sets and Accessories, Games, Gifts & Seasonal, Gift Baskets, Glasses, Globes, Gloves, Golf Equipment and Gift sets (containing or partially containing golf balls, head covers, shoe bag, iron cleaning brush, wooden tees, towel, ball marker chips, tees, travel bag and cart/carrying bag), Glassware, Hats and Headwear, Helmets & Accessories, Headphones and Headsets, Headrest Covers, Highlighters, Hitch Covers, Home & Office, Housewares, Ice Scrapers, Jackets, Jewelry, Jotters, Journals, Keys, Key Blanks, Key Chains and Key Fobs, Kitchenware, Knives, Ladder Mount Plaques, Lamps, Lanyards and Badge Holders, Laptop Computer Skins, Laser Pointer, Letter Opener, License Plates and Holders, Lighters, Lip Balms, Luggage, Luggage Tags, Lunch Bags and Boxes, Magnets, Markers and Marker Boards, Mats, Meal Carriers/Lunch Kits, Media Cases, Mice, Mini-Bats, Mini-Pucks, Mini-Balls, Mini-Wheels, Mini-Sticks, Mini-Sneakers, Mini-Mouse Pads, Mugs, Multi-Tools, Nail Files, Napkin Holders, NASCAR Gear, Necklaces, Neoprene Drink Koozies, Notebooks, Notepads, Officeware, Padfolios, Panoramas, Papers, Paper Clips, Paper Weights, Pens, Pencils, Pennants, Pet Harnesses, Collars, Leashes and Accessories, Photo or Picture Frames, Pins, Ping Pong Tables, Paddles and Balls, Picnic and BBQ Products, Pill Boxes, Pins, Pit Shirts, Place Mats, Planners, Plastic Model Kit cars, Plates, Plush Novelties, Poker and other game Tables, Poker Chips, Ponchos, Portable Bars, Portfolios, Posters, Prints, Programs, Pucks, Purses, Puzzles, Radios, Remote Control Cars (light/sound/action), Rings, Rulers, Sandals, Seat Belt Covers, Shaving Kit/Bag, Shoes, Shot Glasses, Sleeves, Spa Accessories, Spare Wheel Covers, Speakers, Sport Bottles, Sporting Goods, Stadium Seats, Stands, Staplers, Stationery, Stools, Stress Balls, Sunglasses, Sweatshirts, Hoodies & Fleece, Swimming Pool Sets and Accessories, T-Shirts, Tables (folding and otherwise), Tailgating Accessories, Tank Tops, Tape Measures, Tattoos, Tents (camping, outfitter and screened-in tents), Thermometers, Thimbles, Throw Blankets with Sleeves, Tins (containers), Tires, Toiletry Bags, Tools, Tool Bags, Tool Kits, Totes, Toys, Travelware, Tumblers, Umbrellas, Undergarments, Uniforms, USB accessories, Utensils, Utility Kits, Vases, Vinyl Stickers and Decals, Wall Graphics, Wallets and Money Clips, Watches, Water Bottles and Jugs with and without Sleeves, Wheels, White Boards, Window Clings, Wine Stoppers, Women's Apparel, Wrist Bands.

What is claimed is:

1. A method of decorating an article with a recycled souvenir, said method comprising the steps of:
a) converting at least a portion of said souvenir into a particulate;
b) screen printing a colored ink layer onto said article in a desired souvenir pattern;
c) screen printing a first coat liquid adhesive layer onto said colored ink layer in said desired souvenir pattern;
d) distributing said particulate in a laydown pattern onto said first coat liquid adhesive layer;
e) remove excess particulate from said article not located on said liquid adhesive layer;
f) drying said first coat liquid adhesive layer with said particulate thereon to form a first bonded layer; and
g) screen printing a second coat liquid adhesive layer onto said first bonded layer and thereby forming a multilayer composite.

2. The method of claim 1, wherein said object is a garment and further comprising the step of heat pressing said multilayer composite together.

3. The method of claim 1 wherein said colored ink and said first coat liquid adhesive layer are first combined into a homogenous mixture which is then screen printed onto said article.

4. The method of claim 1, wherein said object is a garment and further comprising the step of marking said garment with indicia indicating the source of said souvenir.

5. The method of claim 1 wherein said souvenir is selected from the group comprising:
a) a tire that has been used by a race car;
b) a hockey puck;
c) a skateboard or skateboard wheel;
d) a football helmet;
e) a football;
f) a baseball;
g) a baseball helmet; and
h) a soccer ball.

6. The method of claim 1 wherein said souvenir pattern resembles the physical shape or a characteristic of said souvenir.

7. An article made according to the method of claim 1, and wherein said article is selected from the group comprising:
a) a garment;
b) a drinking glass; and
c) a tote bag.

8. A method of decorating an article with a recycled souvenir, said method comprising the steps of:
a) converting at least a portion of said souvenir into a particulate;
b) providing an adhesive backing layer on a non-binding release paper;
c) screen printing a colored ink layer onto the adhesive backing layer in a desired pattern;
d) screen printing a first coat liquid adhesive layer over the colored ink layer;
e) distributing the particulate onto said first coat liquid adhesive layer;
f) removing excess particulate from the article not located or bonded on the liquid adhesive layer;
g) drying the first coat liquid adhesive layer with the particulate thereon to form a first bonded layer;
h) screen printing a second coat liquid adhesive layer onto the first bonded layer and thereby forming a multilayer composite;
i) curing the multilayer composite at a curing temperature of approximately 350 Fahrenheit for a duration of between about 30 and 35 seconds; and
j) heat pressing the multilayer composite at a temperature of approximately 375 degrees Fahrenheit for between about 15 and 18 seconds to thereby form the design pattern as a decal; and
k) removing the decal from the release paper and applying the decal to an article.

9. The method of claim 8 wherein said colored ink and said first coat liquid adhesive are first combined into a homogenous mixture which is then screen printed onto said adhesive backing layer.

10. The method of claim 8 wherein said souvenir is selected from the group comprising:
a) a tire that has been used by a race car.;
b) a hockey puck;
c) a skateboard or skateboard wheel;
d) a football helmet;
e) a football;
f) a baseball;
g) a baseball helmet; and
h) a soccer ball.

11. An article made according to the method of claim 8, and wherein said article is selected from the group comprising:
a) a garment;
b) a drinking glass; and
c) a tote bag.

12. A method of decorating an article with a recycled souvenir, said method comprising the steps of:
a) converting at least a portion of said souvenir into a particulate;
b) screen printing a colored ink layer onto a patch of material in a desired pattern;
c) screen printing a first coat liquid adhesive layer over the colored ink layer;
d) distributing the particulate onto said first coat liquid adhesive layer;
e) removing excess particulate from the article not located or bonded on the first coat liquid adhesive layer;
f) drying said first coat liquid adhesive layer with said particulate thereon to form a first bonded layer; and
g) screen printing a second coat liquid adhesive layer onto said first bonded layer and thereby forming a multilayer composite on said patch.

13. The method of claim 12 and further comprising the steps of:
h) curing the multilayer composite at a curing temperature of approximately 350 Fahrenheit for a duration of between about 30 and 35 seconds; and
i) applying said patch to an article.

14. The method of claim 12 wherein said colored ink and said first coat liquid adhesive are first combined into a homogenous mixture which is then screen printed onto said patch.

15. The method of claim 12 wherein said souvenir is selected from the group comprising:
a) a tire that has been used by a race car;
b) a hockey puck;
c) a skateboard or skateboard wheel;
d) a football helmet;
e) a football;
f) a baseball;
g) a baseball helmet; and
h) a soccer ball.

16. An article made according to the method of claim 12, and wherein said article is selected from the group comprising:
a) a garment;
b) a drinking glass; and
c) a tote bag.

17. The method according to claim 1 wherein said particles are deposited in a predetermined specific laydown pattern.

18. The method of claim 17 wherein said particulate is comprised of granular particles each of a predetermined size and shape.
